(19) United States
(12) Patent Application Publication
(10) Pub. No.: US 2023/0398962 A1
(43) Pub. Date: Dec. 14, 2023

(54) METHOD FOR CLEANING AN OPTICAL SURFACE FOR A MOTOR VEHICLE

(71) Applicant: VALEO SYSTEMES D'ESSUYAGE, La Verriere (FR)

(72) Inventors: Margaux BEAUBET, La Verriere (FR); Julien CARRION, La Verriere (FR)

(73) Assignee: VALEO SYSTEMES D'ESSUYAGE, La Verriere (FR)

(21) Appl. No.: 18/246,772

(22) PCT Filed: Sep. 28, 2021
(86) PCT No.: PCT/EP2021/076621

§ 371 Date: Mar. 27, 2023

(30) Foreign Application Priority Data
Oct. 1, 2020 (FR) FR2010025

(51) Int. Cl. B60S 1/48; B60S 1/56

(52) U.S. Cl. CPC B60S 1/486; B60S 1/56; B60S 1/485

(57) ABSTRACT

The invention relates to a method for cleaning an optical surface of an optical system for a motor vehicle, based on a cleaning device having a first and second spray nozzles for spraying a cleaning fluid, the cleaning device being arranged relative to the optical system such that, in the cleaning position, the first spray nozzle sprays the cleaning fluid onto a first portion of the optical surface and the second spray nozzle sprays the cleaning fluid onto a second portion of the optical surface, including activating the first spray nozzle depending on a first state of at least one item of aerodynamic data, and activating the second spray nozzle depending on a second state of at least one item of aerodynamic data.

### TECHNICAL FIELD

The invention relates to a method for cleaning an optical surface, preferably an optical sensor fitted to a motor vehicle.

### BACKGROUND OF THE INVENTION

Nowadays, motor vehicles increasingly comprise automated systems, including especially driving assistance systems which can make it possible, in a lesser degree of autonomy of the vehicle, to assist with or to perform parking maneuvers as well as to carry out, in a maximum degree of autonomy of the vehicle, driving of the vehicle without a driver being present in the vehicle. Such driving assistance systems comprise especially one or more detection devices which are provided with optical sensors capable of detecting an environment of the vehicle and capable of evaluating parameters external to that vehicle. The optical sensors are associated with at least one control unit which is configured to interpret the information so collected and to take the decisions which are necessary as a consequence of that information.

More particularly, the use of autonomous vehicles, without a driver, involves the use of a plurality of optical sensors which are arranged all around the vehicle, so that the control unit has a very precise image of the environment of the vehicle, which image is at least as reliable as the three-dimensional image which a driver could obtain himself.

For example, an optical sensor can be positioned at the rear of the vehicle in order to allow the driver to have a better view of the obstacles that are behind the vehicle when he is executing a parking maneuver.

The optical sensors are thus generally positioned outside the vehicle, exposed to bad weather, dust and/or debris such as, for example, mud splashes or insects which become squashed against the optical surface of the sensor, especially under the effect of the speed of the vehicle.

Over time, the field of detection of such a sensor may therefore be wholly or partially obstructed by such soiling, and it is then found to be necessary to regularly clean the optical surface of the sensor in order to allow it to fulfil its function.

Similar problems are also found in optical transmitters or else light projectors of the motor vehicle.

The object of the present invention is to propose a cleaning solution that is simple, inexpensive, and effective in all cleaning situations, regardless of the type and quantity of dirt present on this surface.

### SUMMARY OF THE INVENTION

To this end, the subject of the invention is a method for cleaning an optical surface of an optical system for a motor vehicle using a cleaning device comprising a first spray nozzle for spraying a cleaning fluid and a second spray nozzle for spraying a cleaning fluid, the cleaning device being arranged relative to the optical system so that, in the cleaning position, the first spray nozzle sprays the cleaning fluid onto a first part of the optical surface and the second spray nozzle sprays the cleaning fluid onto a second part of the optical surface, the method comprising the following steps:
activation only of one of the first and second spray nozzles according to a state, called first state, of at least one aerodynamic datum, and
activation only of the other of the first and second spray nozzles according to another state, called second state, of at least one aerodynamic datum.

Thus, the method according to the present invention guarantees simple and effective cleaning of the optical surface whatever the driving conditions of the vehicle.

According to another aspect, the method comprises a step of comparing said at least one aerodynamic datum with a threshold value, said first state corresponding to a state in which said at least one aerodynamic datum is less than or equal to said threshold value and said second state corresponds to a state in which said at least one aerodynamic datum is greater than said threshold value.

According to another aspect, the first part of the optical surface is arranged at least partially above the second part of the optical surface.

According to another aspect, said at least one aerodynamic datum comprises at least one datum among the speed of the vehicle and at least one meteorological item of information.

According to another aspect, said at least one meteorological item of information comprises at least one datum which makes it possible to characterize it and for example at least one among a wind direction and a wind speed.

According to another aspect, the method comprises a step of measuring said at least one meteorological item of information using a measuring device such as an accelerometer, a wind vane or an anemometer.

According to another aspect, the method comprises a step of determining said at least one meteorological item of information using a computer provided with a geolocation terminal and a server remote from the motor vehicle, the determination step comprising a step of communication between the computer and the remote server.

According to another aspect, the method comprises a step of activating the two spray nozzles.

The invention also relates to a device for cleaning an optical surface of an optical system, comprising a first spray nozzle for spraying a cleaning fluid and a second spray nozzle for spraying a cleaning fluid, the cleaning device being arranged relative to the optical system so that, in the cleaning position, the first spray nozzle sprays the cleaning fluid onto a first part of the optical surface and the second spray nozzle sprays the cleaning fluid onto a second part of the optical surface, the device also comprising:
a means for activating said first and second spray nozzles,
a control element for said activation means configured so as to activate only one of the first and second spray nozzles in a state, called first state, of at least one aerodynamic datum, and to activate only the other of the first and second spray nozzles according to another state, called second state, of at least one aerodynamic datum.

According to another aspect, the first part of the optical surface is arranged at least partially above the second part of the optical surface.

According to another aspect, said activation means comprises a two-way solenoid valve for controlling the first nozzle and a two-way solenoid valve for the second nozzle.

According to another aspect, as a variant, said activation means comprises a three-way solenoid valve for controlling said first and second nozzles.

The invention also relates to the use of the method as described above for cleaning the optical surface of one of the elements among a sensor, an emitter or a light projector of the motor vehicle.

### BRIEF DESCRIPTION OF THE DRAWINGS

Other features, details and advantages of the invention will become apparent upon reading the detailed description below, and upon analyzing the appended drawings, in which:

FIG. 1 schematically illustrates a cleaning system according to the present invention for implementing a cleaning method according to the present invention, in a first operating state;

FIG. 2 schematically illustrates the cleaning system of FIG. 1 in a second operating state;

FIG. 3 schematically illustrates a flow chart of the method implemented in FIGS. 1 and 2.

### DETAILED DESCRIPTION OF THE INVENTION

As illustrated in the figures, the subject of the present invention is a cleaning method, referenced 100, and an associated cleaning device, referenced 1, for cleaning an optical surface 2.

Optical surface 2 is understood to mean any surface of an optical system 3 of a motor vehicle which can be made clean by any cleaning fluid.

The optical system 3 is for example a sensor, an emitter or a light projector of the motor vehicle. Mention may in particular be made of a driving assistance system, a camera or a device of the LIDAR or RADAR type.

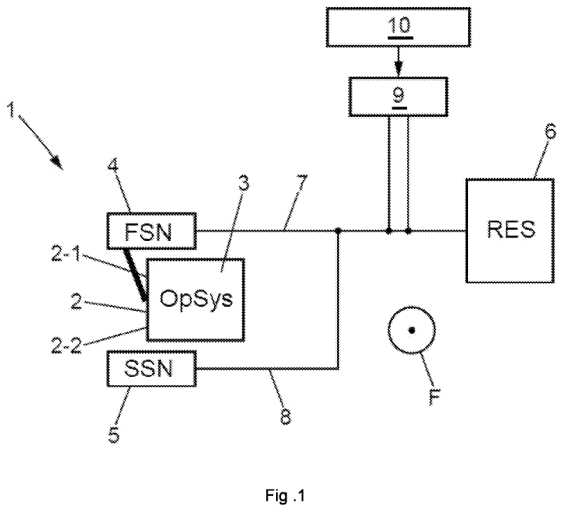

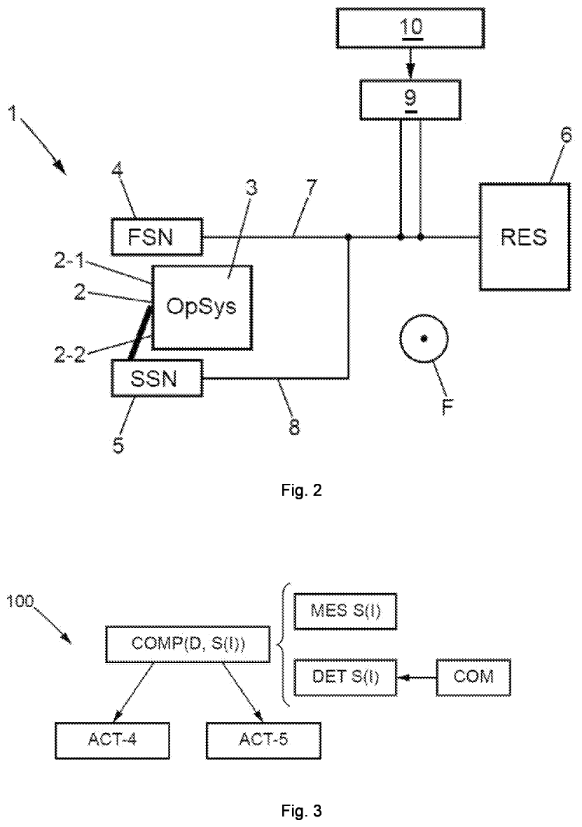

As emerges from FIGS. 1 and 2, the cleaning device 1 comprises a first spray nozzle 4 for spraying a cleaning fluid and a second spray nozzle 5 for spraying a cleaning fluid.

Cleaning fluid is understood to mean any composition making it possible to clean an optical surface 2. For example, this cleaning fluid may thus comprise one cleaning agent or a plurality of combined cleaning agents.

F denotes the flow of air flowing around the optical system.

In FIGS. 1 and 2, there is shown a reservoir 6 for storing the cleaning fluid that is connected, via a channel 7 for the circulation of the cleaning fluid, to the first nozzle 4 and, via a channel 8 for the circulation of the cleaning fluid, to the second nozzle 5.

It is noted that the first nozzle 4 is arranged relative to the optical surface 2 so that, in the cleaning position, the first spray nozzle 4 sprays the cleaning fluid onto a first part 2-1 of the optical surface 2.

It is also noted that the second nozzle 5 is arranged relative to the surface 2 so that, in the cleaning position, the second cleaning nozzle 5 sprays the cleaning fluid onto a second part 2-2 of the optical surface 2.

Preferably, the first part 2-1 of the optical surface 2 is arranged at least partially above the second part 2-2 of the optical surface 2.

The first part 2-1 and the second part 2-2 are separate from each other, although there may be an overlap between the two parts.

The device 1 also comprises a means 9 for activating the first nozzle 4 and the second nozzle 5 of said first and second spray nozzles, as well as a control element 10 for the activation means 9.

According to one variant, the activation means 9 comprises a two-way solenoid valve for controlling the first nozzle and a two-way solenoid valve for the second nozzle. According to another variant, the activation means 9 comprises a three-way solenoid valve for controlling the first and second nozzles 4, 5.

The control element 10 is configured so as to activate only one of the first and second spray nozzles in a state, called first state, of at least one aerodynamic datum, and to activate only the other of the first and second spray nozzles according to another state, called second state, of at least one aerodynamic datum, as will be detailed in relation to the cleaning method 100.

The method 100 implemented by the device 1 will now be described.

The method 100 comprises a step of activating only either the first nozzle 4 or the second nozzle 5 according to a first state of at least one aerodynamic datum D of one of the first and second spray nozzles according to a state, called first state, of at least one aerodynamic datum and a step of activating only either the second nozzle 5 or the first nozzle 4 according to another state, called second state, of said at least one aerodynamic datum.

In FIG. 3, ACT-4 denotes the step of activating the first nozzle 4 and ACT-5 denotes the step of activating the second nozzle 5.

As emerges from the preceding paragraphs, when the nozzle 4 sprays the cleaning fluid, the nozzle 5 is off, and when the nozzle 5 sprays the cleaning fluid, the nozzle 4 is off.

It is noted that said at least one aerodynamic datum comprises at least one datum among the speed of the vehicle and at least one meteorological item of information.

It is also noted that said at least one meteorological item of information comprises at least one datum which makes it possible to characterize it and for example at least one among a wind direction and a wind speed.

The method 100 comprises a step COMP of comparing said at least one aerodynamic datum D with a threshold value, denoted S.

The first state corresponds to a state in which said at least one aerodynamic datum D is less than or equal to the threshold value S and the second state corresponds to a state in which said at least one aerodynamic datum D is greater than the threshold value S.

For example, if the datum D is the speed of the vehicle and the threshold value is a speed of 100 km/h, then the method 100 provides, after comparison during the step COMP, that the first nozzle 4 sprays the cleaning fluid during step ACT-4 for a vehicle speed less than or equal to 100 km/h, the second nozzle 5 being off, while the second nozzle 5 sprays the cleaning fluid during step ACT-5 when the vehicle speed is greater than or equal to 100 km/h, the first nozzle 4 being off.

The spraying by the first nozzle 4 at low speed onto the first surface part 2-1 ensures cleaning of the entire surface 2 with the aid of gravity, which causes the cleaning fluid to descend from the first part 2-1 toward the second part 2-2.

Then, at higher speed, the spraying by the second nozzle 5 onto the second surface part 2-2 ensures cleaning of the entire surface 2 with the aid of the flow of the air flow F, which causes the cleaning fluid to rise from the second part 2-2 toward the first part 2-1.

The threshold value S can depend on the meteorological information I.

According to a first variant, the method 100 comprises a step MES of measuring said at least one meteorological item of information using, for example, an on-board measurement device such as an accelerometer, a wind vane or an anemometer. This first variant provides direct measurement of the meteorological information at the level of the vehicle itself.

According to a second variant, the method 100 comprises a step DET of determining said at least one meteorological item of information using, for example, a computer provided with a geolocation terminal and server remote from the motor vehicle. The determination step DET advantageously comprises a step COM of communication between the computer and the remote server. This second variant avoids equipping the vehicle with an on-board device.

It is noted that the method according to the present invention can also provide for simultaneously activating the two spray nozzles, 4, 5, according to certain circumstances, in particular in the event of heavy soiling, possibly independently of the aerodynamic flow.

It is also noted that, in addition to the preceding description, the method 100 may comprise a step of drying the optical surface 2, for example by a flow of an air flow against the surface 2.

The invention also relates to a use of the method 100 for cleaning the optical surface of an optical system.

What is claimed is:

1. A method for cleaning an optical surface of an optical system for a motor vehicle using a cleaning device comprising including a first spray nozzle for spraying a cleaning fluid and a second spray nozzle for spraying a cleaning fluid, the cleaning device being arranged relative to the optical system so that, in the cleaning position, the first spray nozzle sprays the cleaning fluid onto a first of the optical surface and the second spray nozzle sprays the cleaning fluid onto a second part of the optical surface, the method comprising:
activating the first nozzle according to a first state of at least one aerodynamic datum, and
activating the second spray nozzle according to a second state of the at least one aerodynamic datum, with the first state being different than the second state.

2. The method as claimed in claim 1, further comprising comparing the at least one aerodynamic datum with a threshold value, the first state corresponding to a state in which the at least one aerodynamic datum is less than or equal to the threshold value and the second state corresponds to a state in which the at least one aerodynamic datum is greater than the threshold value.

3. The method as claimed in claim 1, wherein the first of the optical surface is arranged at least partially above the second part of the optical surface.

4. The method as claimed in claim 1, wherein the at least one aerodynamic datum comprises includes at least one datum among the speed of the vehicle and at least one meteorological item of information.

5. The method as claimed in claim 4, wherein the at least one meteorological item of information includes at least one datum which makes it possible to characterize it.

6. The method as claimed in claim 4, wherein the at least one meteorological item of information includes at least one among a wind direction and a wind speed.

7. The method as claimed in claim 6, further comprising measuring the at least one meteorological item of information using a measuring device such as an accelerometer, a wind vane or an anemometer.

8. The method as claimed in claim 6, further comprising determining the at least one meteorological item of information using a computer provided with a geolocation terminal and a server remote from the motor vehicle with communication between the computer and the remote server.

9. The method as claimed in claim 1, further comprising activating the two spray nozzles.

10. A device for cleaning an optical surface of an optical system, comprising a first spray nozzle for spraying a cleaning fluid and a second spray nozzle for spraying a cleaning fluid, the cleaning device being arranged relative to the optical system so that, in the cleaning position, the first spray nozzle sprays the cleaning fluid onto a first of the optical surface and the second spray nozzle sprays the cleaning fluid onto a second part of the optical surface,
an activator for activating the second spray nozzles, and a controller configured to activate the first spray nozzle in a first state of at least one aerodynamic datum, and to activate the second spray nozzle according to a second state of the at least one aerodynamic datum, with the first state being different than the second state.

11. The device as claimed in claim 10, wherein the first of the optical surface is arranged at least partially above the second part of the optical surface.
